(19) United States
(12) Patent Application Publication
(10) Pub. No.: US 2010/0247780 A1
(43) Pub. Date: Sep. 30, 2010

(54) ROLLER COATING SYSTEM FOR WEB BASED SUBSTRATES

(76) Inventor: Jan R Opsahl, Gjerdrum (NO)

Correspondence Address: FROMMER LAWRENCE & HAUG, 745 FIFTH AVENUE- 10TH FL., NEW YORK, NY, 10151, US

(21) Appl. No.: 12/443,530

(22) PCT Filed: Oct. 6, 2006
(86) PCT No.: PCT/NO06/00346

§ 371 Date: Jun. 18, 2010

(51) Int. Cl. B05D 3/12; B05C 11/02

(52) U.S. Cl. 427/365; 118/111; 118/708

(57) ABSTRACT

Roller coating system for web based substrates, comprising a reservoir roller (2) being partly submerged in a fluid containing reservoir (1), a floating lower roller (4), an intermediate roller (5), an upper rubber roller (6) and an impression roller (7), said intermediate roller (5) and said upper rubber roller (6) being supported in a carriage running in a track (10) whereby the axis of said intermediate roller (5), said upper rubber roller (6) and said impression roller (7) being arranged in the same plane.

The present invention is related to a roller coating system and a method for web based substrates, according to the preambles of the claims.

Prior art processes involving treatment such as conditioning, printing, chemicals coating etc of web based substrates such as paper, plastics, film, textiles etc. to a large extent suffer from problems connected with static electricity, dehydration of the substrate, heat development by hot fusion processes, etc. It is also a disadvantage that start ups are connected with several meters of waste web substrate in most prior art processes.

Attempts have been made to overcome the problems such as such as by supplying water through nozzles, covering the substrate with a silicon based wax etc.

With the roller coating system according to the present invention most of the disadvantages are eliminated or at least decreased. This is achieved with the system and the method according to the present invention as defined by the claims.

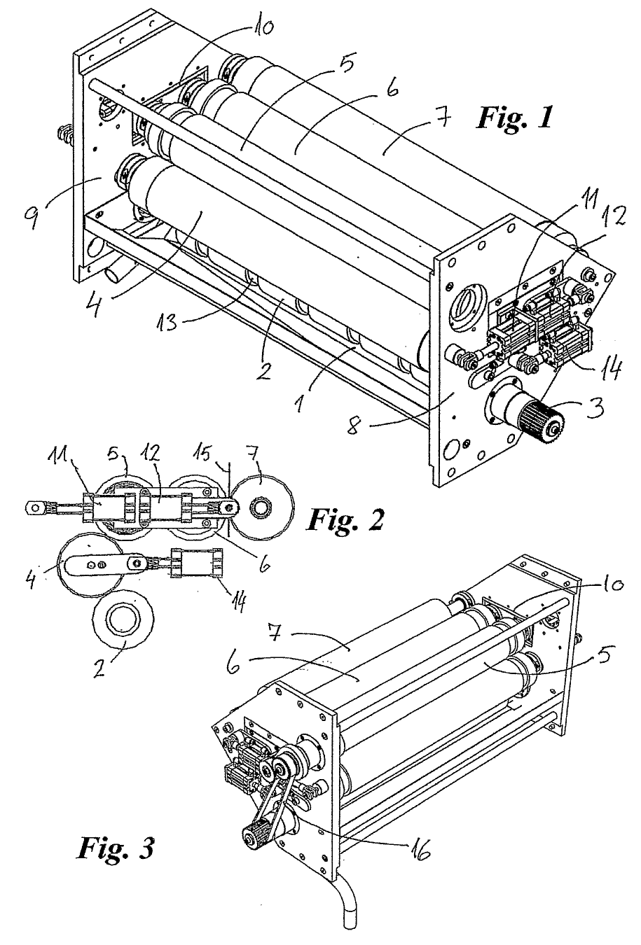

The drawing discloses in FIG. 1 a perspective view of one embodiment of a unit for water supply to a substrate, comprising the roller coating system according to the present invention, FIG. 2 discloses a side view of the unit of FIG. 1 also depicting the rollers, and FIG. 3 discloses in a perspective view of a unit for conservation of a substrate.

A complete roller coating system may comprise units for conservation of a substrate or units for conservation of a substrate as well as a unit for water supply to a substrate.

FIGS. 1 and 2 disclose a unit for water supply of a substrate comprising a reservoir 1 adapted to contain a coating fluid. A reservoir roller 2 is rotated by a separate drive 3 and partly submerged into the fluid and thereby transferring the fluid to a floating lower chromium roller 4. The reservoir roller 2 may preferably be a rubber roller. The lower roller 4 is floating between and being pressed against the reservoir roller 2 and the intermediate rubber roller 5 by control means 14 which may be controlled pneumatically or electrically, thereby to maintain a desired pressure against the reservoir roller 2 as well as against the intermediate roller 5, thereby transferring the fluid to the latter.

From the intermediate roller 5 the fluid is transferred to an upper rubber roller 6 which transfers the fluid to the web substrate 15 by pressure against an impression roller 7.

The lower roller 4, the intermediate roller 5, the upper rubber roller 6 and well as the impression roller 7 are rotated by the web substrate itself.

The reservoir roller 2 is supported in bearings in the two side walls 8 and 9 of the unit. The purpose of the reservoir roller 2 is to transfer fluid from the reservoir 1 to the lower roller 4. As such transfer primarily is carried out by the faces of slots 13 in the reservoir roller 2, said faces being perpendicular to the axis of the reservoir roller 2. Parameters for the transfer of fluid to the lower roller 4 are the outer diameter of the reservoir roller 2, the inner diameter of the slots 13, the distance between the slots 13 as well as the rotational speed of the reservoir roller 2.

The intermediate roller 5 and the upper rubber roller 6 are supported in a carriage running in a linear track 10. The carriage is displaced in the track 10 by control means 11 thereby displacing the impression roller 7 and the upper roller 6 in relation to the impression roller 7. A further control means 12 is displacing the intermediate roller 5 in relation to the upper rubber roller 6. The axis of the intermediate roller 5, the upper rubber roller 6 and the impression roller 7 are preferably all arranged in the same plane.

Said control means 11 and 12 may be adjustable electrically or pneumatically to control the pressure and distance between the upper rubber roller 6 and the impression roller 7 as well as the pressure and the distance between the intermediate roller 5 and the upper rubber roller 6 thereby continuously to maintain a desired pressure between said rollers. The unit may contain programs for setting of parameters for specified purposes.

During normal operation the intermediate roller 5, the upper rubber roller 6 and the impression roller 7 are mutually pressed against each other and driven by the web substrate. During temporary pauses, however, the carriage and thereby the intermediate roller 5 together with the upper roller 6 is moved away from the impression roller 7. The upper rubber roller 6, the intermediate roller 5 and the floating lower roller 4 thereby are driven by the reservoir roller 2 to maintain the fluid distribution on said rollers. For longer halts, however, the upper rubber roller 6 is removed from the intermediate roller 5 by the control means 12.

Sensors acting on the web substrate 15 before and after entering the impression roller 7 regulate the control means 11, 12, 14 and thereby the transfer and distribution of the fluid from the reservoir 1.

FIG. 3 discloses a unit for conservation of a substrate with a given chemical, comprising the impression roller 7 of the above described unit for water supply to a substrate as well as the upper rubber roller 6 and the intermediate roller 5, the latter may be a rubber roller or a chromium roller. The lower roller 4 may be a rubber roller, the reservoir roller 2 may be a chromium roller, however without the slots 13 of the reservoir roller 2 for the water supply unit. The unit is provided with a special drive 16 for rotation of the roller train during temporary pauses. Said drive is connected to the drive 3 for the reservoir roller 2.

1. Roller coating system for web based substrates, comprising a reservoir roller being partly submerged in a fluid containing reservoir, a floating lower roller, an intermediate roller, an upper rubber roller and an impression roller, characterized in that said intermediate roller and said upper rubber roller (6) being supported in a carriage running in a track whereby the axis of said intermediate roller, said upper rubber roller and said impression roller being arranged in the same plane.

2. Roller coating system according to claim 1, wherein the displacement of said carriage in the track being controlled by control means thereby to displace the intermediate roller and the upper rubber roller in relation to the impression roller.

3. Roller coating system according to claim 1, wherein control means arranged on the carriage controlling the displacement of the upper rubber roller in relation to the intermediate roller.

4. Roller coating system according to claim 1, wherein said reservoir roller comprising slots the faces of which transferring fluid from the reservoir to the lower roller.

5. Method for covering a web based substrate with a fluid, wherein said fluid being transferred from a reservoir to the substrate by a reservoir roller, a floating lower roller, an intermediate roller, an upper rubber roller and an impression roller where the intermediate roller, the upper rubber roller and the impression roller being arranged in the same plane.

6. Roller coating system according to claim 2, wherein control means arranged on the carriage controlling the displacement of the upper rubber roller in relation to the intermediate roller.

7. Roller coating system according to claim 2, wherein said reservoir roller comprising slots the faces of which transferring fluid from the reservoir to the lower roller.

8. Roller coating system according to claim 3, wherein said reservoir roller comprising slots the faces of which transferring fluid from the reservoir to the lower roller.
